(19) United States
(12) Patent Application Publication
(10) Pub. No.: US 2009/0236870 A1
(43) Pub. Date: Sep. 24, 2009

(54) Tailgate storable tonneau cover

(75) Inventor: Antonio Emanuel Duncan, Detroit, MI (US)

Correspondence Address: Mr. Antonio Duncan, 6664 Townsend, Detroit, MI, 48213, US

(73) Assignee: Antonio Emanuel Duncan, Detroit, MI (US)

(21) Appl. No.: 12/077,212

(22) Filed: Mar. 19, 2008

(51) Int. Cl. B60J 7/20

(52) U.S. Cl. 296/136.04

(57) ABSTRACT

The proposed invention is a truck bed cover that has the ability to be folded into a compact shape and then stored inside of, or as part of an associated tailgate.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

My invention can be generally classified as a truck bed cover and more specifically as a rigid and foldable tonneau cover.

Tonneau covers are typically deployed atop a pickup truck's cargo box to protect it and its contents from environmental conditions such as rain, snow, hail, wind, airborne or falling debris, sun exposure . . . et cetera. Tonneau covers also reduce the truck's fuel consumption by making the truck's cargo box more streamline.

A problem I have identified with the tonneau covers currently available to consumers is that when the cover is removed from a deployed position atop the truck's cargo box you have no place on the vehicle other than the truck's cargo box to store it.

The tonneau cover I have invented can be removed from its position atop the truck's cargo box and folded into a compact shape, and then placed inside of or onto an associated tailgate that has a built-in storage space for the folded tonneau cover.

### BRIEF SUMMARY OF THE INVENTION

The general idea of my invention is a rigid tonneau cover for a pickup truck bed that is lightweight, easily removable from a position atop the truck's cargo box, and able to be folded into a compact shape. The folded tonneau cover will then be placed inside of the truck's tailgate which is constructed to open up and receive the folded tonneau cover in an internal storage cavity, or the folded tonneau cover will attach to a recess built into the tailgate.

The aforementioned process of removing and storing the tonneau cover can be reversed when one wishes to place the tonneau cover in the deployed configuration.

This new type of tonneau cover along with its associated tailgate allows you to carry the tonneau cover on the vehicle at all times without sacrificing space in the cargo box or passenger cab even when the tonneau cover is not in the deployed configuration.

### BRIEF DESCRIPTION OF THE SEVERAL VIEWS OF THE DRAWING

The features of this invention will be made more fully and clearly apparent from the following description made in connection with the accompanying drawings wherein like reference numbers and characters refer to similar parts throughout the several views, and in which:

FIG. 1 is a perspective view of a pickup truck with the panels of the invention shown in the deployed (unfolded and atop the cargo box) configuration.

FIG. 2 is a perspective view of the panels of the invention shown unattached from a vehicle and fully unfolded.

FIG. 3 is a perspective view of the rear section of a pickup truck with the panels of the invention in the deployed configuration.

FIG. 4 is a perspective view of the rear section of a pickup truck with the panels of the invention in stage 1 of the folding process.

FIG. 5 is a perspective view of the rear section of a pickup truck with the panels of the invention in stage 2 of the folding process.

FIG. 6 is a perspective view of the rear section of a pickup truck with the panels of the invention in stage 3 of the folding process.

FIG. 7 is a perspective view of the rear section of a pickup truck with the panels of the invention in stage 4 of the folding process.

FIG. 8 is a perspective view of the rear section of a pickup truck with the panels of the invention in stage 5 of the folding process.

FIG. 9 is a perspective view of the rear section of a pickup truck with the panels of the invention in stage 6 (final stage) of the folding process. The tailgate of the invention is shown in the horizontal position with its access hatch open thus exposing an internal storage cavity.

FIG. 10 is a perspective view of the rear section of a pickup truck with the folded panels stored inside the associated tailgate.

FIG. 11 is a perspective view of the rear section of a pickup truck with the folded panels of the invention stored inside the associated tailgate, and the access hatch of the tailgate closed, thus hiding the panels from view.

FIG. 12 is a perspective view of a typical connection between the panels of the invention.

### DETAILED DESCRIPTION OF THE INVENTION

In the following description of the invention like numerals and characters designate like elements throughout the figures of the drawings.

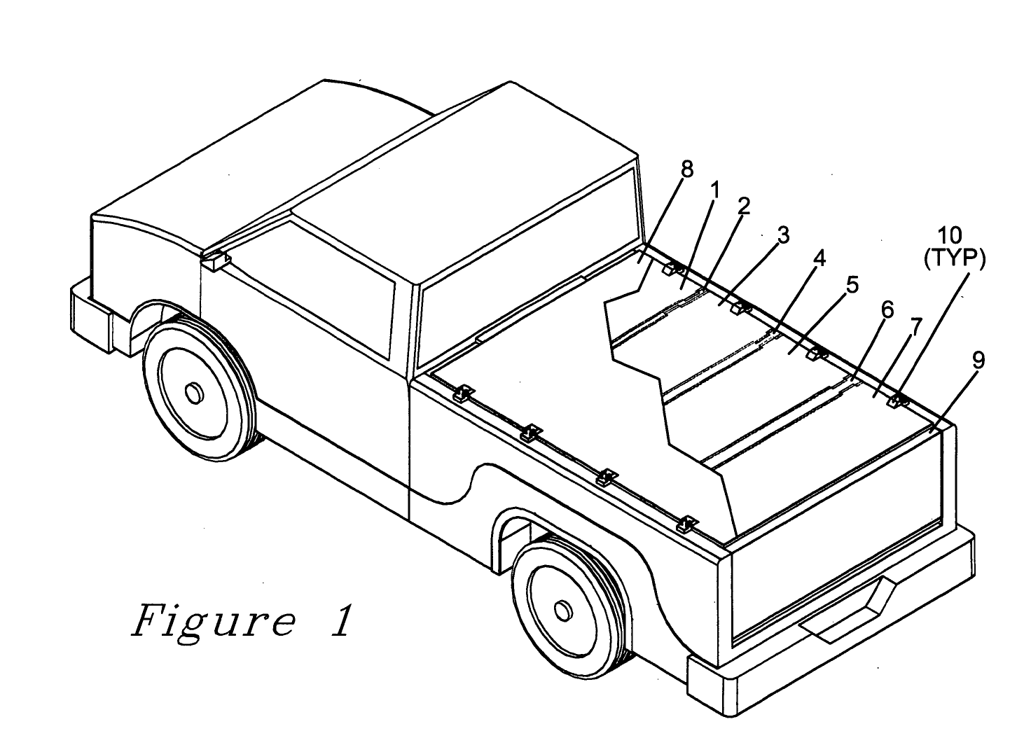

The invention also referred to herein as the tonneau cover or truck bed cover is comprised of substantially rigid and generally rectangular panels 1-7 hinged together along their longitudinal edges. The invention's panels 1-7 extend transversely across the top opening of a pickup truck's cargo box (see FIG. 1).

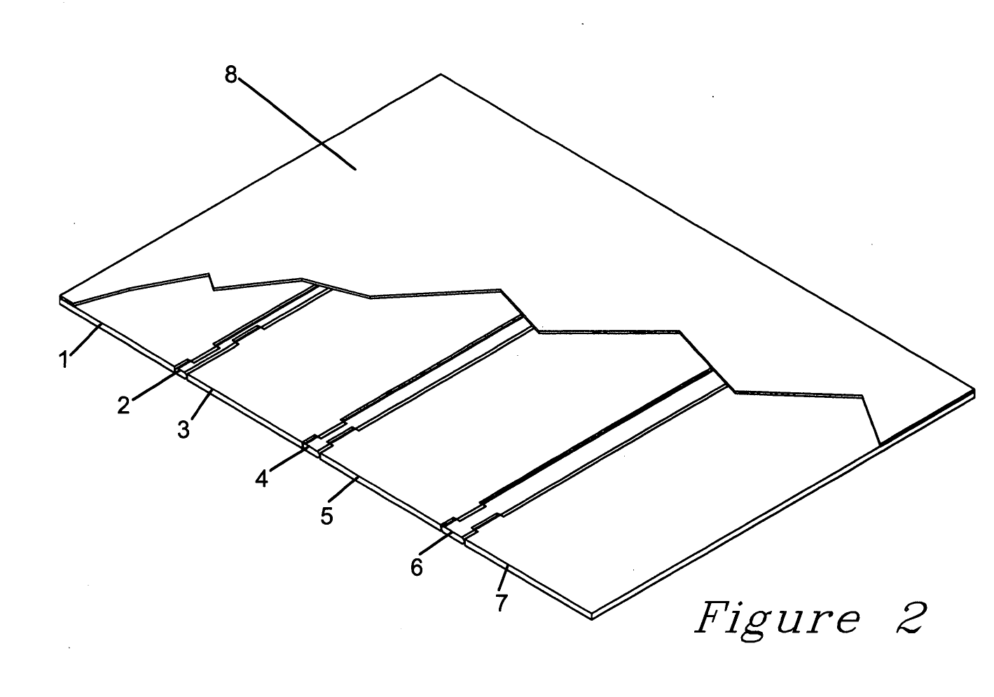

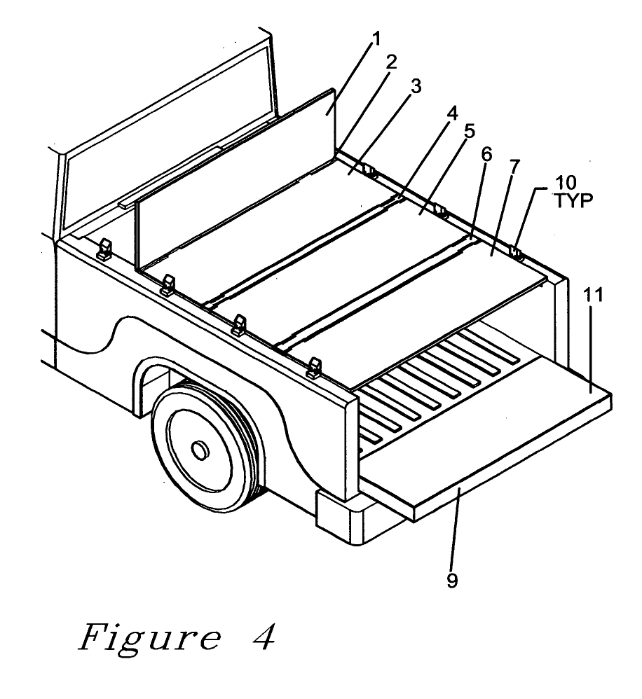

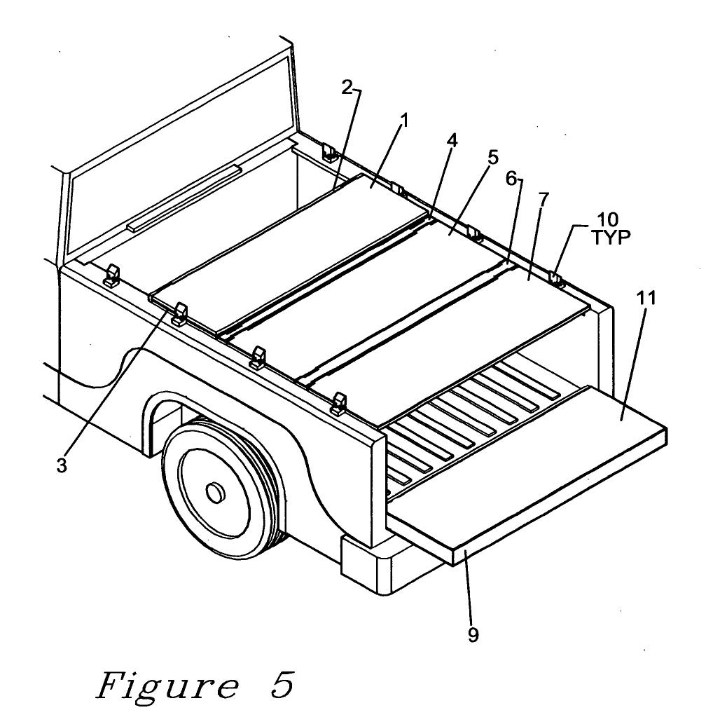

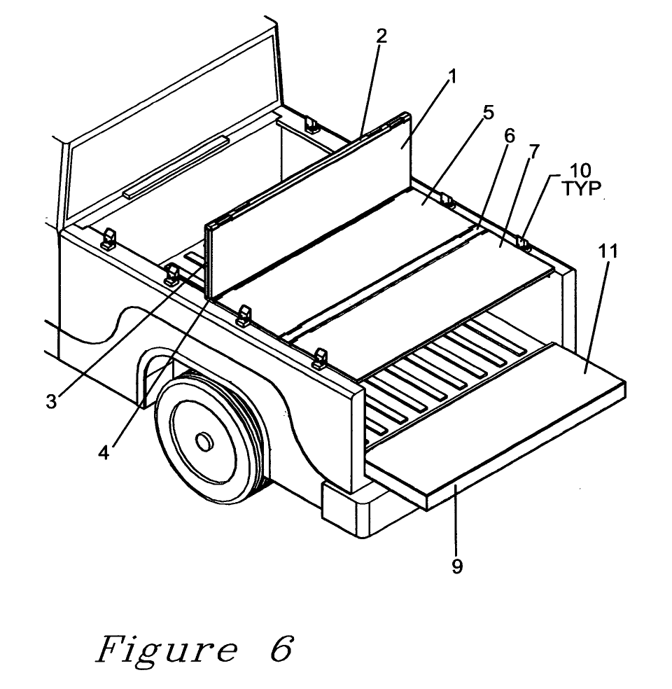

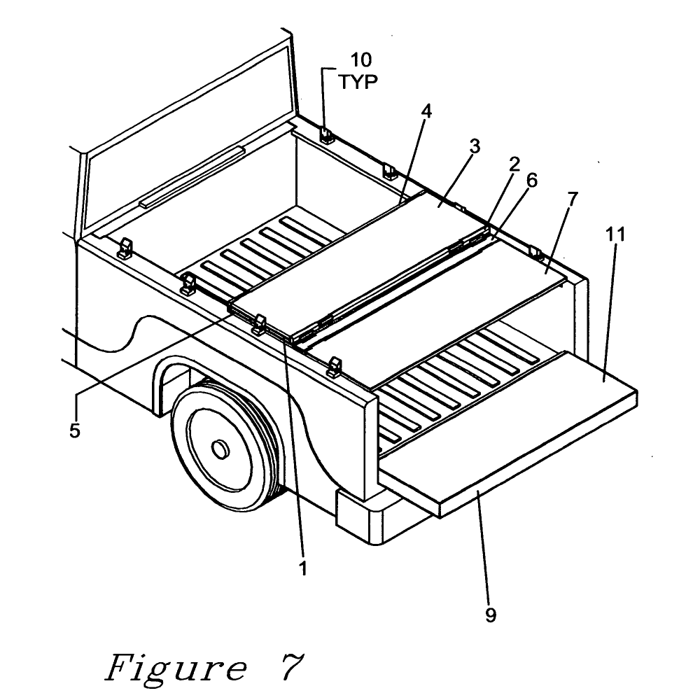

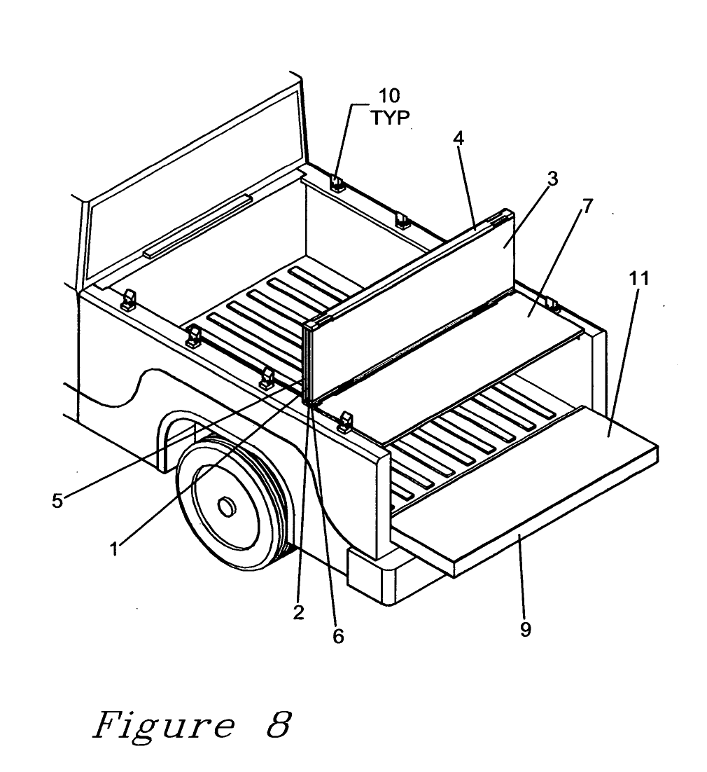

Referring to FIGS. 4-9 the invention's panels 1-7 are hinged together to allow them to be folded onto each other until all the panels 1-7 are brought into a single compact stack-like configuration. An optional moisture repellant fabric cover 8 (shown in a partially cut-away view in FIGS. 1 and 2) can be adhered to the exterior sides of the panels 1-7, this optional fabric cover 8 is flexible and does not interfere with the aforementioned folding process of the panels 1-7.

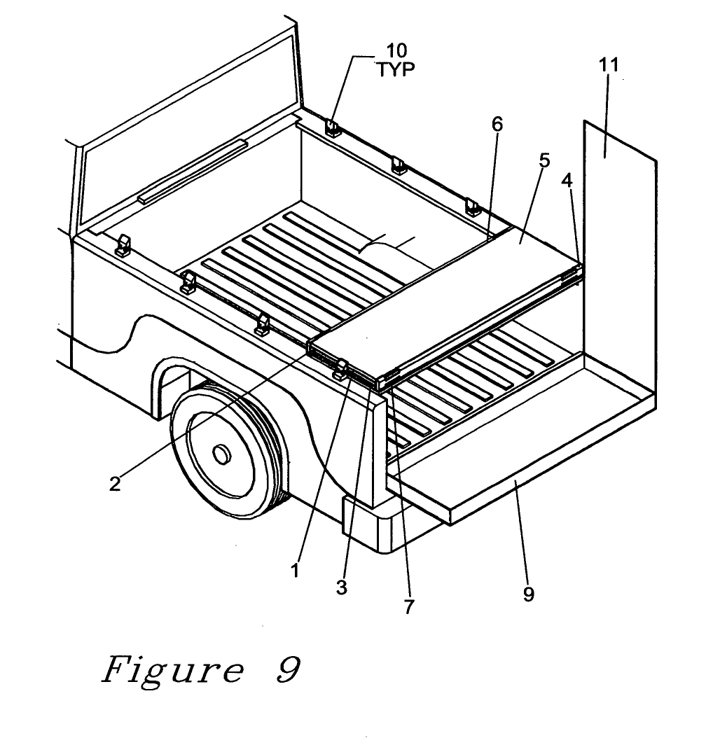

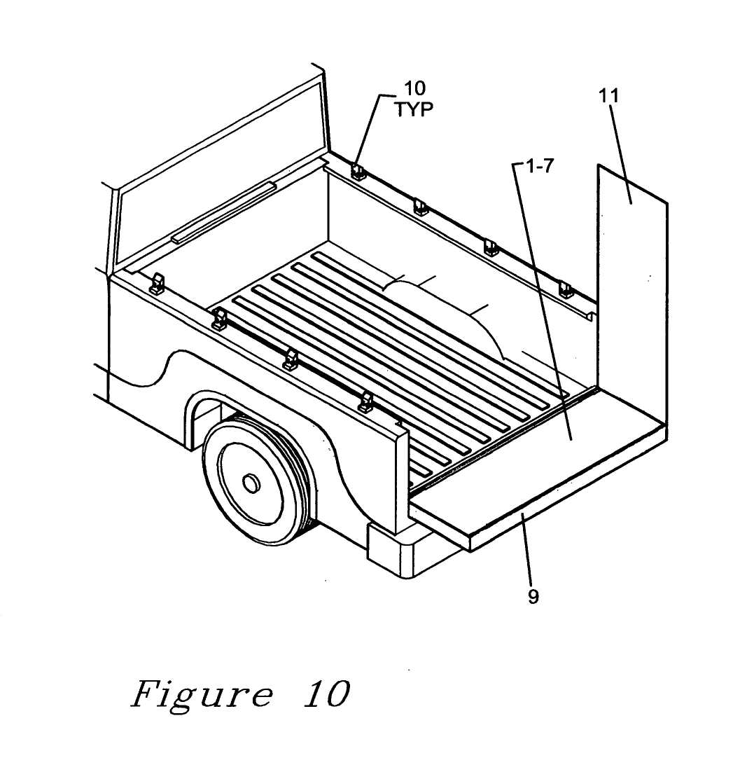

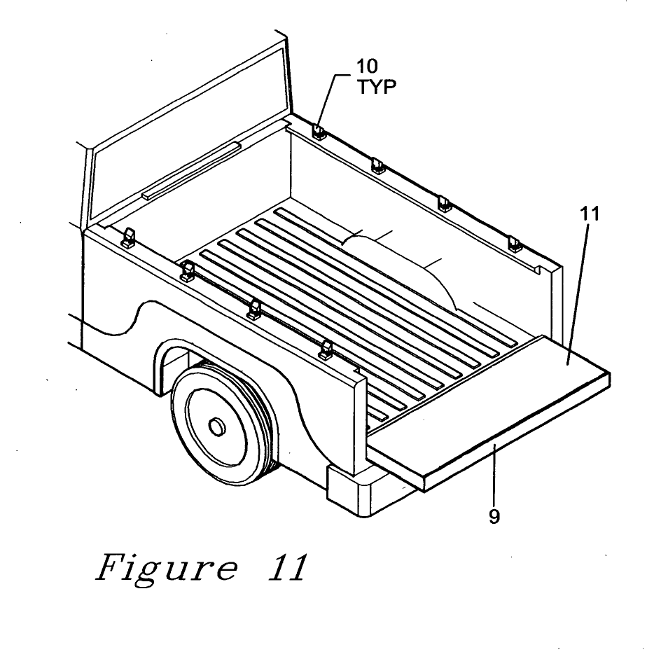

Referring to FIGS. 9-11 the tailgate 9 component of the invention has an access hatch 11 that opens to a cavity inside the tailgate 9, this cavity is dimensioned to serve as a storage compartment for the folded panels 1-7 of the invention. Once the invention's folded panels 1-7 are placed inside the tailgate 9 the access hatch 11 is closed, thus concealing the panels 1-7 from view.

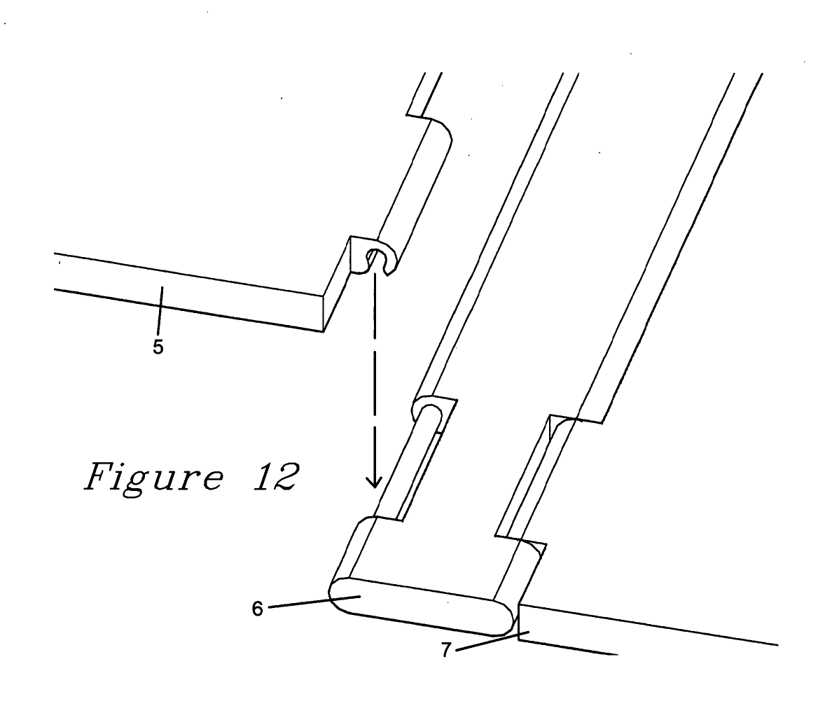

Referring to FIG. 12 what is shown is a close-up view of a connection between panels 7 and 6, and a dashed line and arrow showing the direction of movement for panel 5 as it will be moved in order to connect to panel 6. The connection shown is a snap-together hinge type of connection. The connection shown allows each panel 1-7 to rotate 180 degrees. The connection shown in FIG. 12 is typical of all connections between the panels 1-7 of the invention.

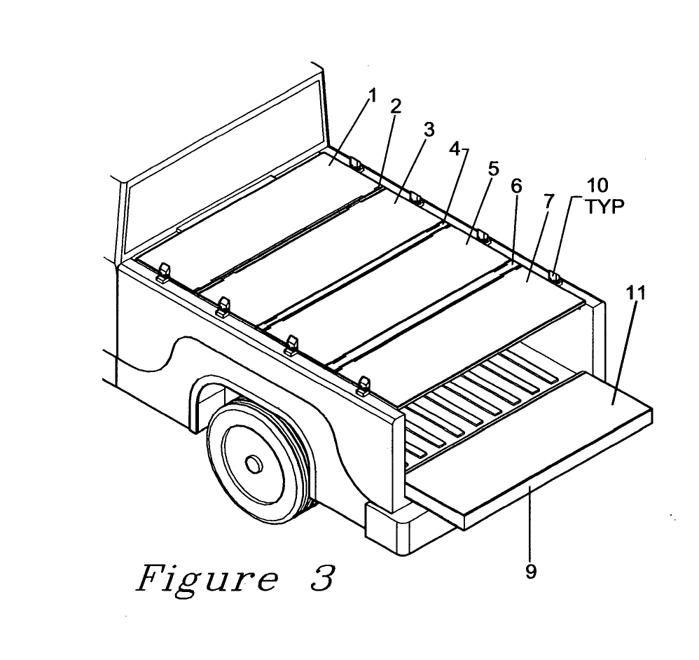

Clamps 10 attached along the tops of the vertical sidewalls of the pickup truck's cargo box serve the purpose of holding the panels 1-7 firmly in the deployed position (see FIG. 1), these same clamps 10 can be released when one wishes to move or fold the panels 1-7 (see FIGS. 3-11).

Referring to FIGS. 3-10, and 12 the panels 1-7 of the invention are shown without the optional fabric cover 8, this choice is made to give the readers of this patent application an unobstructed view of the invention's panels 1-7, thus giving a better understanding of the invention's structure and operation. The invention functions in the same manner with the fabric cover 8 attached as it does with the fabric cover 8 not attached.

The following is a description of the preferred materials used in the fabrication of the invention. The larger panels 1, 3, 5, and 7 are to be molded from high strength plastic or fiberglass. The smaller panels 2, 4, and 6 are to be made from spring steel treated to prevent corrosion. The optional fabric cover 8 is to be made from a material that resists the penetration of moisture such as vinyl; this fabric cover 8 will be attached to the external sides of the panels 1-7 with a waterproof adhesive. The exterior skin of the tailgate 9 is to be made from sheet metal, while the internal components of the tailgate 9 such as the structural supports (not shown), and locking mechanisms (not shown) used to hold the tailgate 9 firmly in the vertical position, should be made from metal of suitable thickness and strength to give the tailgate 9 adequate functionality and durability.

The above described device is not limited to the exact details of construction, composition of materials, or enumeration of parts provided herein. Furthermore, the shape and size can be varied. Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A truck bed cover dimensioned to cover a truck bed, wherein the truck bed is an opening defined by two spaced-apart, generally vertical, and generally parallel to each other sidewalls, a generally vertical tailgate at the rear end of and at a right angle to the sidewalls, and a generally vertical wall adjacent to the passenger cabin, at a right angle to the sidewalls, and at the opposite end of the sidewalls as the tailgate; this truck bed cover comprising: a plurality of substantially rigid and generally rectangular panels hinged or flexibly connected along their longitudinal edges so as to allow the panels that comprise the truck bed cover to be folded onto their adjacent panels until all the panels are brought into a single compact stack or stack-like shape.

2. A tailgate as mentioned in claim 1 associated to the truck bed cover of claim 1 wherein the tailgate has an externally accessible internal storage cavity, or a built-in recess: either of which are dimensioned to serve as a storage compartment or storage area for the truck bed cover of claim 1, wherein the truck bed cover of claim 1 is folded into the compact stack or stack-like shape mentioned in claim 1.
